(19) United States
(12) Patent Application Publication
(10) Pub. No.: US 2008/0208715 A1
(43) Pub. Date: Aug. 28, 2008

(54) METHOD, SYSTEM AND APPARATUS FOR PROVIDING A PERSONALIZED ELECTRONIC SHOPPING CENTER

(76) Inventors: Ronen HOD, Shoham (IL); Itamar Gilad, Kiryat Haim (IL); Yechiam Yemini, Fort Lee, NJ (US); Sivan Perry Tafla, Petach-Tikva (IL); Jimmy Levy, Moshav Yarkona (IL); Nir Michalowitz, Caesaria (IL); Shirley Grill, Tel Aviv (IL); Sara Bitan-Erlich, Hadar-Am (IL)

Correspondence Address: Pearl Cohen Zedek Latzer, LLP, 1500 Broadway, 12th Floor, New York, NY, 10036, US

(21) Appl. No.: 12/038,130

(22) Filed: Feb. 27, 2008

Related U.S. Application Data
(60) Provisional application No. 60/903,830, filed on Feb. 28, 2007.

(51) Int. Cl. G06Q 30/00

(52) U.S. Cl. 705/27

(57) ABSTRACT

According to embodiments of the present invention, a user's local storage system may be used to create a virtual personal mall comprising one or more virtual personal stores and configured for purchasing products by one or several providers. The virtual personal store and/or virtual personal mall may be organized in virtual shelves. Each virtual shelf may contain a group of products with one or more common properties, for example, books by a certain author and/or published by a certain publisher, and/or supplied by the same virtual personal store provider, etc. The groups may be defined by the virtual personal store provider and/or by the user and/or by a group of users.

### CROSS-REFERENCE TO RELATED APPLICATIONS

This application claims the benefit of U.S. Provisional Patent Application No. 60/903,830, filed on Feb. 28, 2007, which is incorporated in its entirety herein by reference.

### FIELD OF THE INVENTION

This invention relates to the field of Content Distribution Networks CDN and, in particular, to methods and systems for e-commerce applications.

### BACKGROUND OF THE INVENTION

Current electronic stores or “e-stores” available on a computer network, e.g., Internet Websites for selling clothes, movies, kitchenware, music, etc., typically use client-server infrastructures. An e-store provider may deploy servers that maintain the e-store's content, present it to remote users over the computer network and support their shopping and purchasing. Users must typically actively search for items and providers of interest to them, typically using third party Internet search engines or other remote merchandise aggregation services, then transact over the network with remote servers of the provider to shop and purchase items of interest. The providers are typically restricted to passively awaiting users to visit their sites. Providers must typically establish relationships with search engine providers to attract users' transactions traffic.

There is a need for a more efficient apparatus, system and method for allowing electronic shopping for users.

### SUMMARY OF THE INVENTION

According to embodiments of the present invention, the emergence of massive personal storage devices may be used to dramatically improve e-shopping processes by using a local personal storage device as a shopping medium. A user's local storage system may be used to create a virtual personal mall comprising one or more virtual personal stores and configured for purchasing products by one or several providers. In accordance with certain aspects of the present invention, there is provided a system and method enabling local on-line and/or off-line browsing, marketing and ordering of tangible or physical products, as well as local delivery of products configured to be delivered in electronic form, referred to herein as meta-products. Meta-products may include any electronic content products e.g. books, movies, CDs, etc. and any e-documents related to physical products e.g. promotional clips, technical descriptions, manual, catalogues, etc. Meta-products may be distributed to a user's personal storage device, in which they may be arranged in one or more virtual personal stores, which may in turn be grouped into a virtual personal mall, enabling a user to shop and purchase products and services when the computer is connected to the network online, or not connected offline. Embodiments of the present invention present methods to provide and distribute meta-products to, display, search, transact with and manage a virtual personal mall, and its associated virtual personal stores, stored in the user's personal storage device.

In accordance with certain embodiments of the present invention, the content products may be also delivered via the virtual personal store and/or virtual personal mall. The content products include any product which is configured to be delivered in electronic form; e.g. books, newspapers, games, various software applications, music, videos, etc. Some of these content products may be also delivered in a physical form e.g. books, CDs, DVDs, etc. The content products may be stored in the virtual personal store and/or virtual personal mall, and be ready for ordering, purchasing, delivery and/or direct consumption therefrom. Typically, large volumes of content may be stored while only a small part of such content may be consumed.

A virtual personal store provider may be responsible for stocking, e.g., replenishing, discarding, maintaining, deleting, meta-products, from the virtual personal store, for example, based on a shelf-life, or a time parameter for expiry.

Among advantages of the invention may be availability required by the user of content with no need to be fetched from the content provider. The content owned by the content provider may be very dynamic, versatile, and arrive in large quantities of required memory. The tasks of exposing the user to these large amounts of rich content, and delivering megabytes, gigabytes, or even terabytes of content to millions of user per day, may be challenges to content providers and distributors, which may be addressed by embodiments of the invention. The virtual personal store and virtual personal mall of the present invention introduce a content organizations and display method, which may enable better and more convenient user exposure. Among advantages of certain embodiments of the invention may be that the provider can customize, and/or allow the user to customize, the virtual personal store to best meet the user's specific interests; simplify search and purchase transactions; use rich video to render e-shopping similar to real-shopping and more intuitive; enable the user to pursue shopping experience at any time and place of interest even when they are off-line and do not have a network connection; actively engage the users to serve their personal needs best, develop long term bonding and maximize their shopping efficiency. Physical products obviously cannot be delivered to the virtual personal store, however, certain digital content relating to physical products, for example, brochures and/or datasheets may be delivered directly, optionally accompanied by content improving the virtual shopping experience, and the user can purchase the product directly from the brochure or the datasheet.

The virtual personal store and/or virtual personal mall may be organized in virtual shelves. Each virtual shelf may contain a group of products with one or more common properties, for example, books by a certain author and/or published by a certain publisher, and/or supplied by the same virtual personal store provider, etc. The groups may be defined by the virtual personal store provider and/or by the user.

The virtual personal mall may comprise one or more virtual personal stores and be configured to communicate with one or more provider's servers via a content distribution network. The virtual mall may be arranged analogously to a real mall, where the shelves with the user's favorite products, from stores in the mall, are located in the user's premises, yet are replenished by the stores' owners each time they are emptied, the products expires, or the stores wish to expose browsers to some products or product lines.

Among advantages of the present invention may be facilitating off-line purchasing and delivery. For example, a user may pursue such shopping regardless of having a network connection, e.g., on a long flight, or a train ride, etc. The transaction details may be synchronized with the provider's remote systems when the user re-establishes network connection. Optionally, the user may use an off-network connection to complete the transaction when the network connection is off-line.

The virtual personal mall may user common infrastructures to simplify and unify the organization, operations and usage of virtual personal stores. The virtual personal mall may include facilities to enable users to select, provision or delete virtual personal stores from their personal storage device; configure storage and bandwidth resources to be allocated to virtual personal stores; establish and/or unify payment and credit mechanisms to transact with virtual personal stores; provide data on personal interests to best configure virtual personal mall services; browse and search products and services through their virtual personal mall; obtain data on new offerings, special sales and various other events provided by virtual personal stores or the virtual personal mall; and transact purchases with virtual personal stores.

In accordance with certain aspects of the present invention, there may be provided a method for operating a virtual personal mall on a personal storage device and a system thereof.

In some embodiments of the invention, the virtual personal mall may be configured to facilitate the user to provide at least one from the following features.

Users may select and populate their virtual personal mall with virtual personal stores of interest and assign storage and bandwidth resources to it. Users may customize a virtual personal store/virtual personal mall to meet their interest in goods and services. Users may obtain regular updates of products and of sales events, distributed to their storage by the virtual personal store provider. Users may monitor and pursue virtual personal store/virtual personal mall events, e.g., special sales at virtual personal stores. Users may pursue rich video presentations of shopping experiences and virtual personal store/virtual personal mall offerings. Users may join or establish a community with shared virtual personal mall and, optionally, shared virtual personal store, and may conduct shared shopping with other members of the community and enjoy respective benefits e.g., a community discount or specials. Users may pursue the above activities directly from a personal storage through multiple systems including personal computer PC, mobile phone, television, set-top box STB, or other displays. Users may pursue all the above activities offline at any time regardless of availability of a network connection; synchronize these offline transactions with remote systems upon re-establishing a network connection. Users may pay for virtual personal store/virtual personal mall purchases of goods and services using a range of payment methods supported by virtual personal store providers, from payment for individual goods e.g., to purchase a DVD or jewelry to subscription and pay-per-view e.g., a virtual movies rental store; or, use ad-sponsorship to pay for content services; or, participate in an auction e.g., for a limited number of “tickets” to a downloaded movie.

In some embodiments of the invention, providers of items to virtual personal stores may decide upon a shelf-life of a product, after which time, it may cease to be offered. In some embodiments, users may mark a desired item as permanent, in which case, it may not disappear from the user's virtual personal shelf in the virtual personal mall.

Users may create personalized mall views, created by search engine running on the mall. Users may receive content products directly via the virtual personal store/virtual personal mall.

### BRIEF DESCRIPTION OF THE DRAWINGS

In order to understand the invention and to see how it may be carried out in practice, an embodiment will now be described, by way of non-limiting example only, with reference to the accompanying drawings, in which:

FIG. 1 is a schematic depiction of a system of entities participating in a virtual personal mall operation according to embodiments of the invention;

FIG. 2 is a schematic depiction of a virtual shelf according to embodiments of the invention;

FIG. 3 is a block diagram of virtual personal store entities according to embodiments of the invention;

FIGS. 4 and 5 are schematic depictions of methods for providing virtual shelf definitions and storage processes according to embodiments of the invention;

FIG. 6 is a schematic depiction of a product save method according to embodiments of the invention;

FIG. 7 is a schematic flow chart describing product consumption tracking according to embodiments of the invention; and

FIG. 8 is a block diagram of a virtual personal mall according to embodiments of the invention.

### DETAILED DESCRIPTION OF EXEMPLARY EMBODIMENTS

In the following detailed description, numerous specific details are set forth in order to provide a thorough understanding of the invention. However, it will be understood by those skilled in the art, that the present invention may be practiced without these specific details. In other instances, well-known methods, procedures, components and circuits have not been described in detail so as not to obscure the present invention. In the drawings and descriptions, identical reference numerals indicate those components that are common to different embodiments or configurations.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or processor or similar electronic computing device, that manipulate and/or transform data represented as physical, such as electronic, quantities within the computing system's registers and/or memories into other data, similarly represented as physical quantities within the computing system's memories, registers or other such information storage, transmission or display devices.

The processes/devices presented herein are not inherently related to any particular electronic component or other apparatus, unless specifically stated otherwise. Various general purpose components may be used in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The term “content provider” used in this patent specification should be expansively construed to include any entity or person who owns and provides the content products, e.g., Disney™, Virgin™, Barnes and Noble™, etc.

The term “merchant” used in this patent specification should be expansively construed to include any entity or person who owns and provides products for sale.

The term “advertiser” used in this patent specification should be expansively construed to include any entity or person who creates a campaign and pays the distributor for the execution of the campaign according to an agreement between them.

The term “distributor” used in this patent specification should be expansively construed to include any entity or person who owns the CDN, and distributes the content and the advertisements to the users.

The term “user” used in this patent specification should be expansively construed to include any entity or person who consumes the content and the advertisements.

The term “personal storage” used in this patent specification should be expansively construed to include any platform or part thereof facilitating keeping certain content in full user's custody, including storage platforms directly connected to a home network, portable storage platforms, off-line storage devices and other local storage platforms. The personal storage may be capable to obtain data from an external network; may be incorporated as part of a PC, as a PC attachment; incorporated in a mobile device e.g. cellular phone, palm-top computer, media player, etc., a digital video recorder DVR, a set top box, an electronic game system, TV set; a network attached storage NAS appliance connected to a home network; provided as an independent network-enabled storage system, etc.

The virtual personal mall may comprise one or more virtual personal stores and be configured to communicate with one or more server of a provider. The products in or associated with the virtual personal mall and/or virtual personal store may be grouped into or associated with virtual shelves. Information pertaining to the virtual personal mall, virtual personal stores, virtual shelves, and products contain in or associated with any of the above may be stored on a personal storage device of a user.

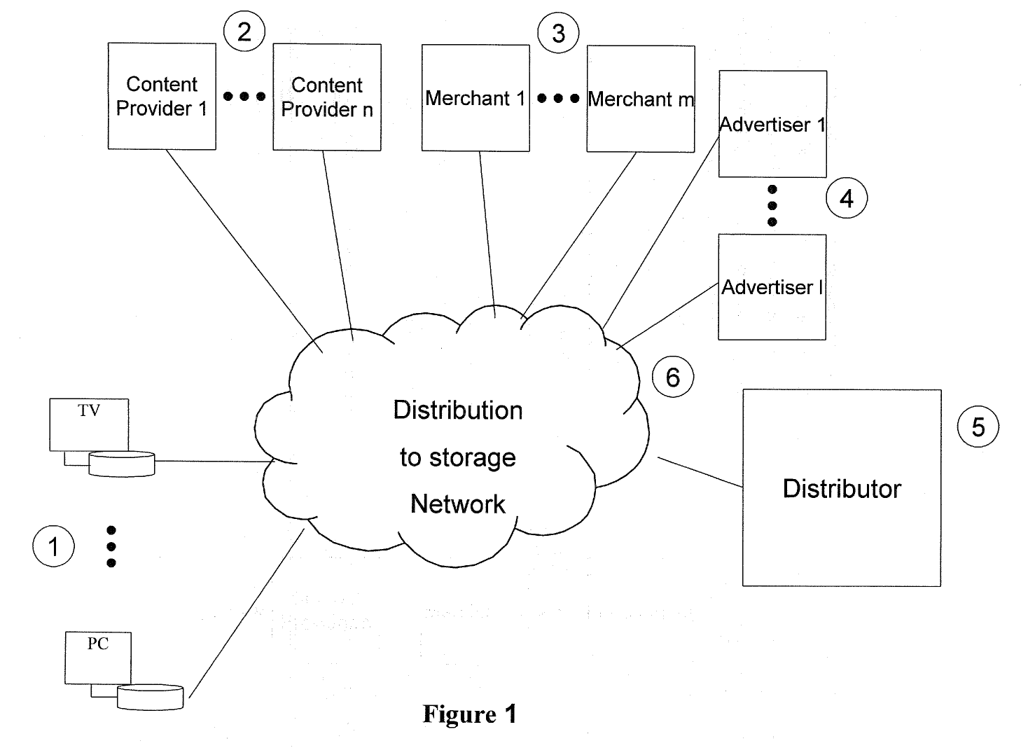

The stores and the malls may be configured or defined by the user, who may choose which items will be in each virtual personal store, and which virtual personal stores will be in the virtual personal mall. The participants in the virtual personal store/virtual personal mall operations depicted in FIG. 1:

The user 1 may define the virtual personal mall and virtual personal store in a personal storage device belonging to and/or associated with the user. As seen in the figure, the user's personal storage end device may be a computer, e.g., a desktop or laptop computer, television, set-top box, mobile device, e.g., phone, personal digital assistant PDA, or any other suitable computing device capable of maintaining communication with a network, and having storage, display and input devices.

The content providers 2, merchants 3, and advertisers 4, may respectively provide content, physical products catalogs and advertisements to the network of virtual personal malls. The term virtual personal store provider may be used herein to denote any or all of these three entities. The virtual personal store provider may select the items which will be distributed to the virtual personal stores according to a policy and configuration defined by the user. The distribution method may be performed, for example, by push initiated by virtual personal store provider, or pull initiated by the user device, but the details of the distribution network and method are outside the scope of the present invention. The virtual personal store provider may use transmissions to all, a group of some, or individual users to provide products, meta-products, and other information.

The distributor 5, may control and manage access to the distribution to storage network 6. Among the distributor's tasks may be to create the connection between a virtual personal store provider 2, 3 and 4, and its users. It may be the responsibility of distributor 5 to enable distribution of selected products from the virtual personal store provider 2, 3 and 4, to appropriate users. There may be several methods a distributor 5 might use to create the connection. One possible way may be to construct a list of users who selected a specific subset of the virtual personal store provider's products, and send it to the virtual personal store provider. Another possible method may be to provide the users who selected the subset with a group identity, and any user who joins the group may receive all the selected products. The users 1 may perform the selection through the virtual personal store. The distributor may further control the access to the network 6 in order to minimize network resource consumption, and/or handle network congestion. The distributor may handle all the control traffic in the system; but the content/products need not be routed through the distributor, but may be transmitted directly from the virtual personal store providers 2, 3 and 4 to the users 1.

The above participants may be configured to communicate through the distribution to storage network 6, which may connect the participants, and provide the distribution to storage infrastructure. The network 6 can be private, shared or public.

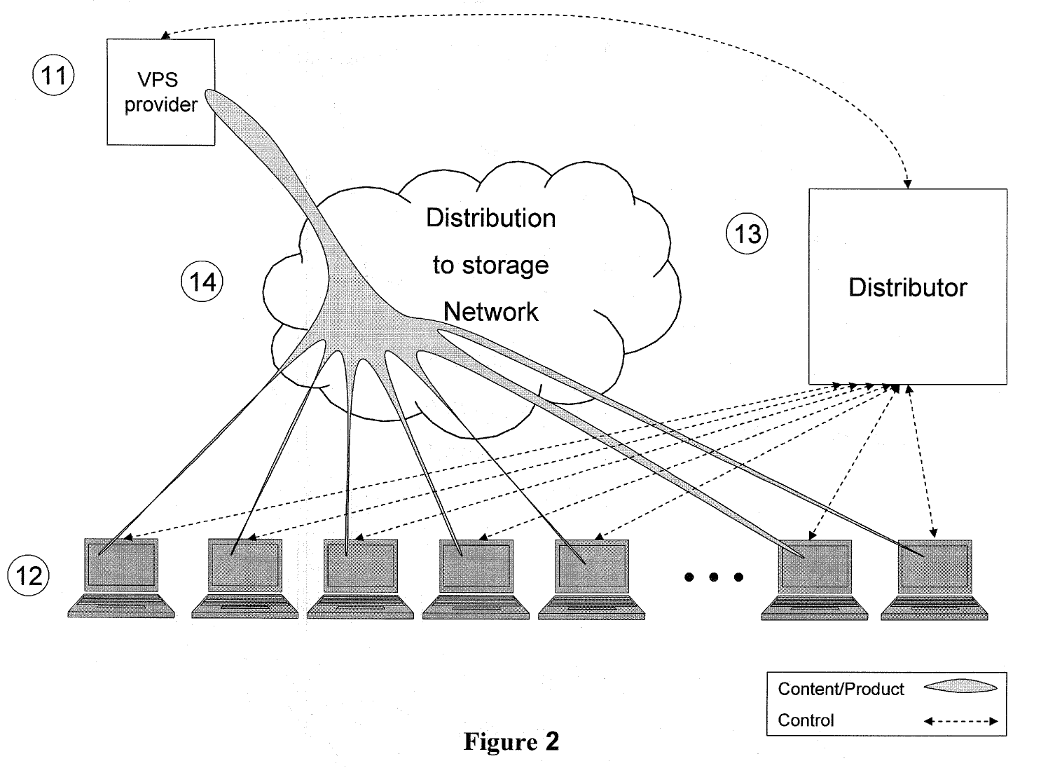

The virtual personal store/virtual personal mall may be organized in virtual shelves. A virtual shelf may be implemented in the user's personal storage, and it may be allocated to a single virtual personal store provider. A virtual shelf is an abstraction defined by its contents, its provider, e.g., all detergents for Persians carpets cleaning from Walmart™, and the users who currently have this virtual shelf in their virtual personal store. FIG. 2 is a visualization of a virtual shelf. The virtual personal store provider 11 may define the collection of all the virtual shelves it supports. End users 12 may choose the virtual shelves in their virtual personal store/virtual personal mall from a list of available virtual shelves from different virtual personal store providers, or may define virtual shelves based on parameters of their creation. The virtual shelf may be replenished by the virtual personal store provider, using its configured interfaces to the distribution to storage network 14, according to policy configured by the user and the distributor 13. The distributor 13 may receive selections by the end users 12, and supply the virtual personal store provider 11 and the end users 12 with information required for the virtual shelf construction. As seen in the figure, the virtual shelf control may be handled by the distributor 5, but the virtual shelf itself need not be routed through the distributor, but transmitted directly from the virtual personal store provider 11, to the end users 12 using configured interfaces to the distribution to storage network 14.

The virtual personal store provider 11 may sometimes use the virtual shelf to promote newly available meta-products, and place samples of new products, for example, content products, which might match profiles of current virtual shelf users on the virtual shelf. The virtual shelf may be stored in a distributed manner across the provider's server, and the personal storage of its users. The virtual shelf content might vary in time, in which case it is updated by the virtual personal store provider 1. The personal storage of a user of a certain virtual shelf may contains only some of the products in the virtual shelf. The policy which dictates which parts are stored in personal storage is constructed from policies configured by the distributor 13 and the user 12.

A possible method for the implementation of a virtual shelf according to embodiments of the invention is as follows: each virtual shelf may have a per-distributor unique shelf identity and a dynamic shelf identity assigned by the distributor 13. It should be noted that the invention is not bounded a single distributor embodiment described by way of non-limiting example. Likewise, virtual personal store providers may participate in virtual personal store/virtual personal malls controlled by different distributors, in which case they may define identical virtual shelves for all distributors, which will be assigned different unique shelf identities by each distributor. The dynamic shelf identity is variable, and it is associated dynamically with the virtual shelf, by the distribution to storage algorithm. Virtual shelf users may join and leave groups when association/de-association happens. Since the groups are formed in a distributed dynamic manner, momentarily group membership cannot be tracked, not even by the distributor 13 and the distribution to storage algorithm.

A virtual personal store/virtual personal mall may include several application, which may be run on servers and client machines belonging to entities depicted in FIG. 2, the virtual personal store provider 11, the distributor 13 and the users 12.

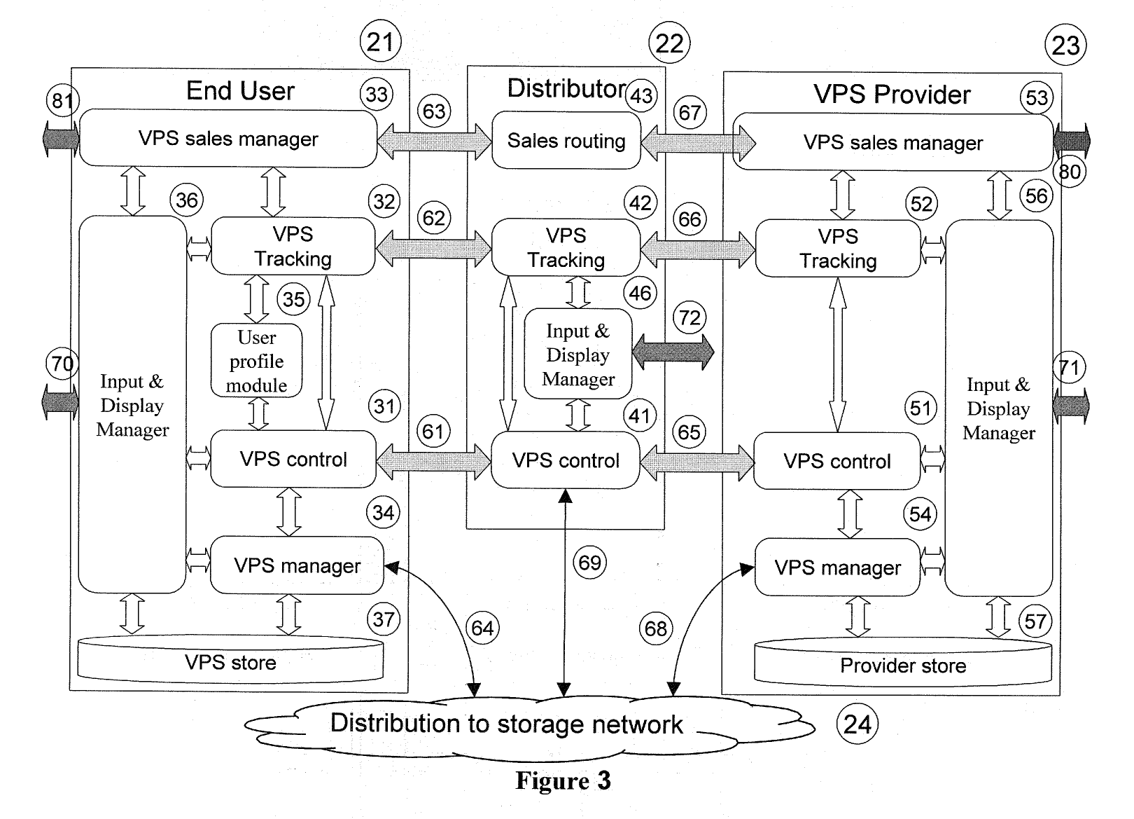

Bearing the above in mind, attention is drawn to FIG. 3 which contains a high level block diagram of a virtual personal store distributed across the user's machines 21, the distributor's servers 22, the virtual personal store provider servers 23, and the distribution to storage network 24, all according to embodiments of the invention. It should be noted that other embodiments of the invention may comprise blocks implemented at the user's machine and/or personal storage and be configured to interact with external blocks implemented at distributor's and/or service provider's servers. The main parts of a virtual personal store are four distributed applications or modules, including: virtual personal store control, virtual personal store tracking, virtual personal store sales manager and virtual personal store manager.

The virtual personal store control 31, 41 and 51, may be responsible for the constructing, configuring, and maintaining the user's virtual personal store; building and handling the list of virtual shelves in the virtual personal store; for each shelf, managing the shelf policy, which defines parameters like shelf replenishment frequency, the amount of storage allocated to this shelf, the amount of bandwidth allocated to it, etc. It may also create the connections between the virtual personal store provider and all the users who have virtual shelves in their virtual personal stores either by assigning a dynamic shelf identity to a virtual shelf, or by maintaining the virtual shelf's current list of users, and it may also be used in virtual shelves tracking. The virtual personal store control may be a distributed application, composed of modules 31, 41 and 51 running on the end user's machine 21, the distributor's server 22 and the virtual personal store provider's server 23, respectively. The user's virtual personal store control 31 may be configured to communicate through interface 69 with the distribution to storage network 24, through interface 61 with the distributor's virtual personal store control 41, and through interface 65 with the provider's virtual personal store control 51.

The virtual personal store manager 34 and 54 may be responsible for he replenishing and maintaining the user's virtual shelves, which may be done according to parameters dictated by the virtual personal store control.

The virtual personal store manager may be a distributed application, composed of the virtual personal store provider's virtual personal store manager 54, and the user's virtual personal store manager 34. Both modules may be configured to communicate through interfaces 64 and 68 respectively with the distribution to storage network 24. The virtual personal store provider's virtual personal store manager 54, may retrieve the desired data, e.g., physical products catalog's or brochures, virtual products, from the provider store 57, which may be shared by several virtual shelves provided by the same provider, and handle its distribution to the users' virtual personal store manager 34, which may store them in the user's virtual personal store 37, which may be shared by all the user's virtual shelves.

The virtual personal store manager may be responsible for product distribution, as it may manage access to the network 24 through a respective interface, it may also be responsible for the control of network resource consumption, and the handling of network congestion. However, these mechanisms are part of the distribution system and need not be described herein.

Virtual personal store sales manager 33, 43 and 53, may be a client-server distributed application, responsible for presenting, executing and securing transactions to sell products, deliver products and collect payments.

Virtual personal store tracking 32, 43, and 52 may be a distributed application, responsible for tracking of virtual shelves present in the user's virtual personal store, and their content, and of products purchased by the user. The tracking manager may also build the user profile, managed by the user profile module 35 in the user's machine. The user profile module may be used for targeted advertising, promotion and to enhance the virtual personal store construction by the virtual personal store control 31, 41 and 51.

In addition, each entity 21, 22 and 23, may have a local input and display manager 36, 46 and 56, respectively, responsible for communicating with the virtual personal store user, the distributor administrator and the virtual personal store provider administrator respectively. The user's input and display 36 manager may be responsible for the display of the virtual personal store using views defined by the user; it may interact directly with the virtual personal store 37, which contains all the virtual shelves in the virtual personal store.

Virtual personal store control handles the virtual shelves. It enables creation, definition, modification and maintenance of virtual shelves. The virtual personal store provider 23 may use the virtual personal store control 51 to define the virtual shelves it provides through the input and display manager 56.

The distributor's 22 virtual personal store control 41, aggregates all the virtual shelves definition it receives from all the virtual personal store providers in the network of virtual personal stores. The end user 21 can use its virtual personal store control 31, and its input and display manager 36 to view the distributor 22 list of available virtual shelves, and select the virtual shelves in its virtual personal store. The user's virtual personal store control 31 can optionally consult the user profile module 35, when selecting the virtual personal store providers and virtual shelves to be displayed and their order making sure, for example, that the virtual shelves matching the user's taste and habits will be located in the first places in the list. It can also consult the user profile module 35 during the creation of virtual shelf policy.

Each virtual shelf may have a policy attached to it, composed of distribution, storage, replenishment and deletion policy. The policy is defined in a distributed manner by the virtual personal store participants, end user 21, distributor 22 and provider 23. The policy includes rules dictating among other things content in storage life-time, products arrival time, e.g., the current episode of a particular television series should arrive not less than two hours before TV broadcast time, and more. It might also include bandwidth usage restriction as agreed between the distributor and the carrier. Some of the rules are defined by the virtual personal store provider 23, e.g., product arrival time, and replenishment policy, e.g., which products should be removed from the shelf when new products arrive. Other rules are defined by the distributor 22, e.g., bandwidth usage restrictions, for example, this shelf can be replenished only during off-peak hour, and use a certain percent of available bandwidth. Additional rules might be defined by the user, e.g., the amount of storage allocated to this virtual shelf. An advertisement virtual shelf has special policies, defining campaigns.

The policy is implemented by the virtual personal store managers 34 and 54 residing on the user 21 and the distributor 22 machines respectively, and by the distribution to storage network 24. The distributor's virtual personal store control 41 controls the distribution of products to the users' virtual personal store, and among other things takes care of arbitration between different virtual personal store providers and different shelves, and to the assignment of dynamic shelf identity to unique shelf identity, or to the maintenance of the virtual shelf users' list. It may also be responsible for virtual shelf usage tracking. The details of the virtual personal store managers 34 and 54 and the distributor's virtual personal store control 41 respective interfaces with the distribution to storage network 24 are not relevant to the present invention and need not be discussed herein.

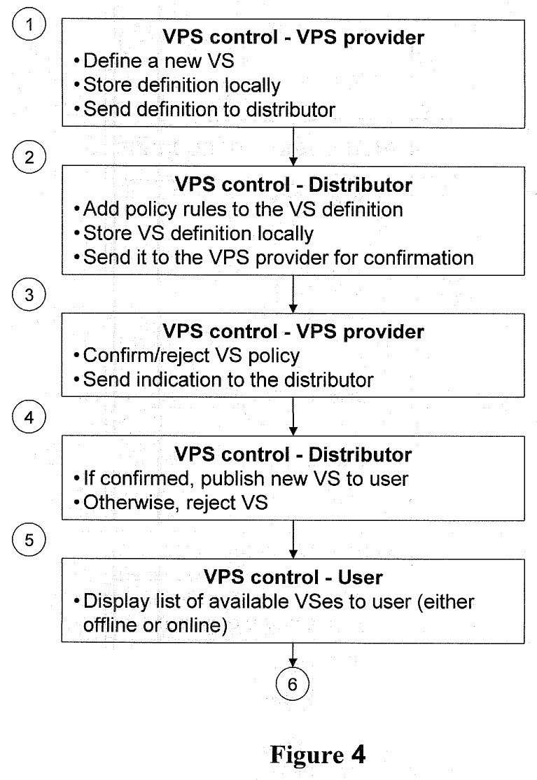

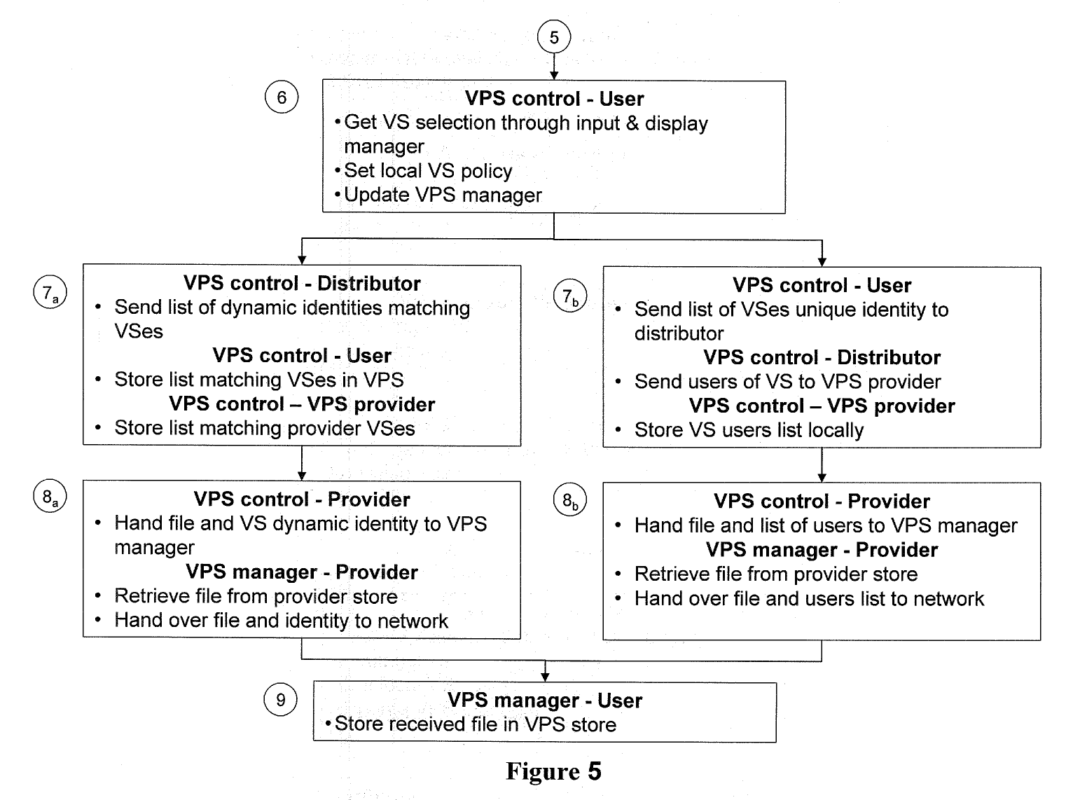

FIGS. 4 and 5 contain a flow chart describing an example of process defining a virtual shelf in a user virtual personal store, and storing a file representing a product on a virtual shelf.

In a first step, the virtual personal store provider administrator uses his virtual personal store control 51 to define new virtual shelf, through his input and display manager 56. The definition of the channel includes information such as: the virtual personal store provider identity, the virtual shelf identity, which content products are stored on this shelf, replenishment policy, etc. In addition it contains some requirements concerning distribution e.g. arrival time, delays etc. The definitions are stored by the virtual personal store control 51, and sent through interface 65 to the distributor 22.

In a next step, the distributor's virtual personal store control 41 displays the new virtual shelf definition to the administrator through its display and input manager 71. The distributor administrator views the definition and the guidelines, and configuration parameters such as: the bandwidth allocated to the virtual shelf, the virtual shelf distribution times e.g. 2-3 AM etc. It stores the definitions locally, and sends them to the virtual personal store provider 23 for conformation.

In a next step, the virtual personal store provider's virtual personal store control 51 receives the new virtual shelf definitions, and either confirms them or rejects them.

In a further step, the distributor's admin views the virtual personal store provider's confirmation/rejection through his input and display manager. If the definitions are confirmed, then they are published to the distributor's user. Two methods are possible here: the definition are sent to the users; a pointer to the definition store, on the distributor server is sent to the subscribers.

In a next step, a user wishes to construct a virtual personal store, or modify an existing virtual personal store, has to choose from the virtual shelves list. The list is displayed through the user's input and display manager 36. The list is retrieved either from local virtual shelf store part of the user's virtual personal store control 31, or on-line from the distributor virtual shelf store part of the distributor's virtual personal store control 41, depending on the selection in step 4 above. The list might be sorted according to virtual personal store provider, product's class, or some other sort criteria.

In yet a next step, the user selects one or several virtual shelves from the displayed list, through his input and display manager 36. For each selected virtual shelf, the user can optionally define local virtual shelf policy, which includes parameters such as allocated storage, maximal bandwidth to be used by this virtual shelf, etc. The selected virtual shelves, and their policy is stored in the local virtual shelf store part of the virtual personal store control 31; optionally the local policy can be communicated to the distributor virtual personal store control 41. The selection is also notified to the user's virtual personal store manager 34, who is responsible for the virtual personal store content maintenance.

In a further step, once the user defines his virtual personal store, the process can continue in several alternative ways, depending on the distributor 43, two of which are: a the distributor's virtual personal store control 41 periodically sends a list of virtual shelves dynamic identities matching unique identities to the users' virtual personal store control 31, and to the virtual personal store providers' virtual personal store control 51. The user's virtual personal store control 31 stores in its internal virtual shelf store, the current dynamic identities matching the virtual shelves in the store; the virtual personal store provider virtual personal store control 51 stores the list of dynamic identities matching virtual shelves he provides in its internal store; and b the user's virtual personal store control 31 sends the unique identities of the virtual shelves he selected to the distributor. The distributor, who gets the virtual shelves lists from all its users, sends the user's identifiers which may be an IP addresses to the virtual personal store provider's virtual personal store control 54 who stores it locally.

In a next step, whether due to virtual shelf initialization, or replenishment, the virtual personal store distributor's virtual personal store control 51 determines to add a product to the users' virtual shelves. Depending on the method used in step 7 above, one of two processes may happen: a the virtual personal store provider's virtual personal store control 51 hands over to the distributor's virtual personal store manager 54 an instruction to send a certain file representing a product to a specific dynamic identity. The virtual personal store provider's virtual personal store manager 54, retrieves the file from the provider's store 57, and transfers it together with the matching dynamic identity to the distribution to storage network 24, which transmits the file to all the users who have a virtual shelf with this dynamic identity; and/or b the virtual personal store provider's virtual personal store control 51 hands over to the distributor's virtual personal store manager 54 an instruction to send a certain file representing a product to a specific list of users. The files usually contains data, and some meta-data e.g. for media file title, author, DRM information and access policy; for ad campaign policy etc. The virtual personal store provider's virtual personal store manager 54, retrieves the file from the provider's store 57, and transfers it together with users list through respective interfaces to the distribution to storage network 24, which transmits the file to all the users in the list.

Finally, when the user's virtual personal store manager 34, receives a file destined to a certain virtual shelf in its virtual personal store, it stores the file data and meta-data in the virtual personal store store 37.

A user of the virtual shelf from a provider usually consumes only a fraction of the content stored in his personal storage, and pays only for the content he consumes. To enable this, the content transmitted and stored in the virtual shelf is locked by a cryptographic key. Depending on the business model being used, the user gets the key, after the virtual personal store provider verifies that payment has occurred in the pay-per-view, rent and other models, or can be enforced in others ads sponsored models, the cryptographic key is handed is secure manner to the user device, who decrypts the content, and consumes it.

Virtual personal store control 31, 41 and 51, enables the virtual personal store users to: select virtual shelves in his virtual personal store; configure local and global policies for each virtual shelf; and receive automatically new products to virtual shelves in its virtual personal store.

Any or all of the entities in the system may have a local input and display manger 36, 46 and 56 respectively. All the user's actions are performed through this module, through interfaces 70, 71 and 72. Examples of actions are available in all three entities are: policy configuration, virtual shelf definition creation or update, tracking configuration, tracking report request etc.

On the virtual personal store provider's server, and the users' machines, the input and display managers 36 and 56 interface the virtual personal store store 37 and the provider store 57 respectively, enabling the users and the virtual personal store provider admin to perform operations on the products in the stores. Examples of features using these abilities are: product delete from user or provider store, product save in user store, and product export under certain conditions.

Product save enables the user to make sure a product he wishes to consume in the future, will not be removed from the virtual shelf due to replenishments.

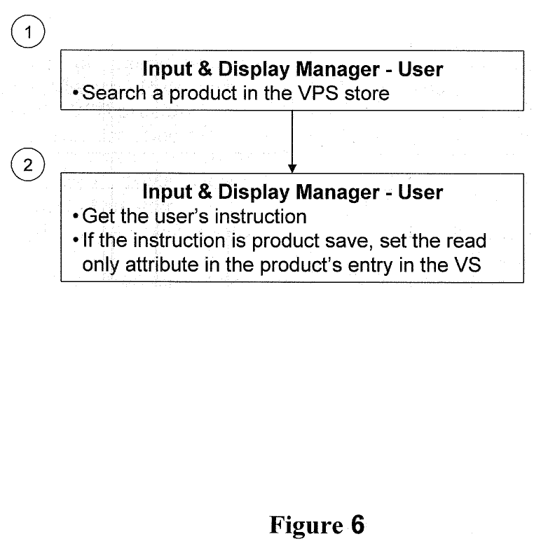

FIG. 6 contains a simple flow chart describing example processes of product save. In a first step, the user uses his local input and display manager 36 to locate a product he wishes to permanently retain in his personal virtual personal store store 37. In a next step, through the input and display manager 36, the user performs a save operation on the product. As a result the input and display manager sets the “read only” attribute in the virtual shelf entry containing the product. When the virtual personal store manager 34 replenishes the personal storage, it does not delete this specific item, since it is marked as read-only.

The user's input and display module 36 is also responsible for presentation of virtual shelves and products in the virtual personal store, and for the presentation of virtual products, once they are consumed. Virtual products might be of various types, and might require players, reader of running environment to be consumed. This module is responsible to the delivery of these virtual products to the appropriate player/execution environment.

A special case is when advertisements are consumed. Ads are many times interlaced within other virtual products sometimes they can be even used to partially subsidize the product. Many virtual products are prepared for ads integration; they contain pointers to places where ads can fit in called spots; the display manager can insert ads into spots according to virtual personal store provider policy, which is part of the virtual product and the advertisement meta-data.

The virtual personal store manager is a distributed application which manages the access to the distribution to storage network 24, the user's virtual personal store store 37 and the provider's virtual personal store store 57. On the virtual personal store provider side it is responsible for the transmission of files representing products or ads to users; on the user's side it is responsible for the receiving and the storage of the products, and the removal of products if necessary according to the replenishment policy enforced by the virtual personal store control 31.

Virtual personal store tracking is a distributed application composed of 32, 42 and 52, which provides various statistics on virtual shelf and products usage in the network of Virtual personal stores; examples of statistics that can be provided are: number of users using a certain virtual shelf, number of users using a combination of certain n virtual shelves this is cross virtual shelf information—e.g., the number of users who has each pair, triple or n-tuple of virtual shelves, etc. in their virtual personal store. As seen in FIG. 3, the end user's virtual personal store tracking 32 reports to the distributor's virtual personal store tracking 42. The distributor 22 receives from all the end users 21 tracking information on virtual shelves by all virtual personal store providers 23; it then filters to the information, and send to each virtual personal store provider only information relevant to him.

Depending on the distribution implementation, the statistics can be collected with or without exposure of the users' products consumption habits; e.g., if virtual personal store control is implemented using the dynamic identities method described above, then only the end user's virtual personal store control and tracking know which virtual shelves appear in the user's virtual personal store e.g., the virtual shelves unique identities. Note that the distribution to storage network 24 knows at each moment all the dynamic identities in the user's virtual personal store, but since it doesn't know the mapping to unique identities, this information doesn't indicate which virtual shelves are actually in the virtual personal store, hence it doesn't violate the user's privacy.

Following are two examples of virtual personal store tracking and reporting processes. It should be noted that among the benefits of the present invention may be that such processes do not violate the subscriber's privacy.

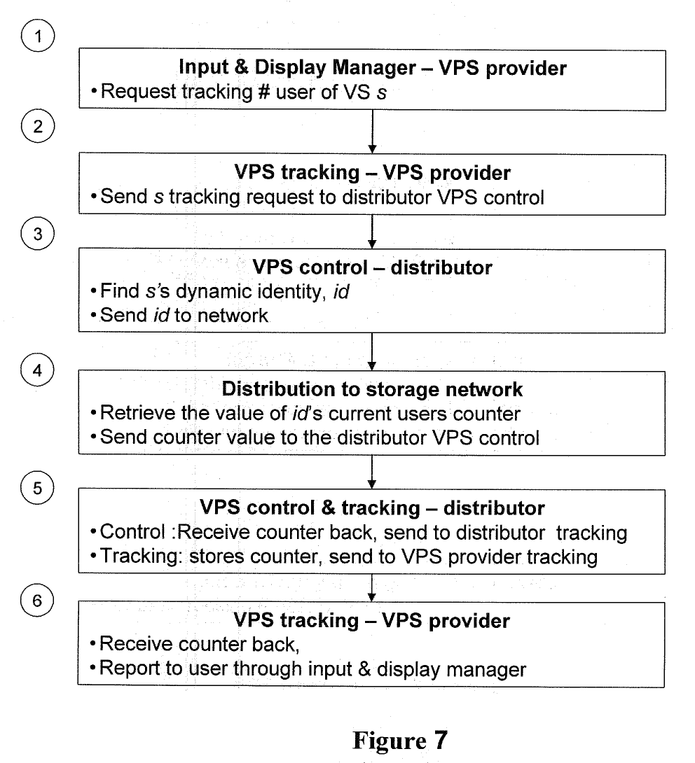

First, tracking the number of users who has a specific virtual shelf s from a certain provider p in their virtual personal store flow chart detailed in FIG. 7. In a first step, p's administrator requests through his input and display manager 71 a report on the number of users who has virtual shelf s in their virtual personal store. In a next step, the virtual personal store tracking 52 sends the query to the distributor's virtual personal store control 41. In yet a next step, the distributor's virtual personal store control 41 finds s's dynamic identity id, and sends the query through a respective interface to the distribution to storage network 24. In a further step, the distribution to storage keeps track of the number of users who has currently has identity id. It keeps a counter per dynamic identity. The implementation and the maintenance of the counter is done by the distribution to storage network 24, which is the subject of another application. The distribution to storage network 24 sends the appropriate counter through a respective interface back to the distributor virtual personal store control 41. In a next step, the distributor virtual personal store control 41 sends the counter back to the virtual personal store tracking 42, who stores it, and sends it back to provider's virtual personal store tracking 52. Finally, the provider's virtual personal store tracking 52, reports back to the administrator through the input and display manager 71.

Second, tracking the number of users subscribed to a certain combination of n virtual shelves s₁, s₂, . . . , sₙ: First, the query might come from the distributor or the virtual personal store provider in this case he can query only about virtual shelf he provides through the input and display manager 46 or 56 respectively. If the origin is the virtual personal store provider then its virtual personal store tracking 52, send the query to the distributor virtual personal store tracking 42. The distributor virtual personal store tracking 42, send the set of n unique shelf identities to the distributor's virtual personal store control 41. If the distributor is using dynamic identities, then it substitutes the unique identities with the matching dynamic shelf identities privacy is preserved only if dynamic identities are used. Next, the distributor's virtual personal store control 41 sends with the query with dynamic or unique to the distribution to storage network 24 through a respective interface. Further, although the distribution to storage network 24 knows the number of users who have each virtual shelf in their Virtual personal stores, it doesn't know the number of users who has a specific combination of virtual shelves in their virtual personal store. Only the end user's virtual personal store tracking can keep track of groups of shelves the user has in its virtual personal store. Thus, the distribution to storage network 24 queries all the users who have at least one of n virtual shelves in their virtual personal store, with the combination of n identities All the users who have the combination of n virtual shelves reply by incrementing a central distributed counter. Finally, the distribution to storage network 24 through a respective interface reports the number of users back to the distributor virtual personal store tracking 42, who reports it back either to the virtual personal store provider virtual personal store tracking 52, and to the input and display manager 71, or to the distributor virtual personal store tracking 42, and input and display manager 46.

Virtual personal store tracking is also capable of tracking products consumption. Like the virtual shelf tracking the end user's virtual personal store tracking 32 is the only one who has the entire user's tracking information, which he can report in similar method like virtual shelf tracking to the distributor 22 and the virtual personal store provider 23. The user profile module 35, process the user's tracking information created by the virtual personal store tracking 32, and constructs a user profile, which the virtual personal store control 31 can consult when giving its inputs for virtual shelf policy, specifically advertisement virtual shelf policy, and during the virtual shelves selection process.

Ad tracking is especially significant since it used by the advertisement virtual personal store provider when it charges its customer since ads payment is many times proportional to the number of ad exposures.

The virtual personal store sales manager is a distributed application composed of the user's virtual personal store sales manager 33, the virtual personal store provider's sales manager 53 and a sales routing 43 part residing at the distributor's, who is responsible for the routing a purchase transaction from the user 22 to the appropriate virtual personal store provider 24. The virtual personal store sales manager is responsible to present, execute and secure transactions to sell products, deliver products and collect payments

As there are two different products types in the virtual personal store, there are two different purchasing processes. Virtual products e.g., content in the virtual personal store are most of the time already in the user's personal storage, hence the purchasing consist of a process to securely receive a key o recover the content, after payment transaction has occurred or enforced. Physical products will be shipped to the user's physical address, after a payment transaction has occurred or enforced.

The following is an example of content shopping process. Through his input and display manager 36 the user requests and receives full or partial list of the virtual product stored in its virtual personal store store 37. The user can also use virtual mall search see below to find a content item. The user selects the item he wishes to consume. Control is transferred to the user's virtual personal store sales manager 33. Depending on the business model, for example: the user gets a request from his virtual personal store sales manager 33 to pay on line for the content item; he accesses virtual personal store provider online sales manager 53, pays for the content, and receives a key that unlocks the content. If a network connection to the online sales manager is unavailable, the transaction will be stalled until the network connection is made available. If the unavailability of the network exceeds a certain threshold, then the virtual personal store sales manager 33, prompts the user through the input and display manager 36, if he would like to cancel the purchase; or the user paid for virtual shelf subscription; he has a subscription proof stored in his local virtual personal store sales manager 33, which presents to virtual personal store provider online sales manager 53 which sends him, in a secure envelope, the key to unlock the content; or the user uses the pay-by-ad model disclosed in application titled “Personal Storage Advertising” filed Jan. 30, 2007 and assigned to the assignee of the present invention. The user's virtual personal store sales manager 33 retrieves the content key from an online server, while declaring that the pay-by-ad model is used. If he already has enough advertisement credit points to pay for the content, the content can be played without advertisements. Otherwise, a local ads server or a remote ads server selects advertisement such that enough advertisement credits points to pay for the content are collected, and inserts them into spots blanks available in the content. The ads server local or remote can optionally consult the user profile module 35. Depending on the usage model Pay-per-view, rent, unlimited etc. the user can now consume the content. As explain above, the consumption is driven by the user's input and display manager 36, who optionally inserts ads into available spots in the content.

The process of physical product purchase is very similar to the process described above. If the user chooses to purchase a physical product than the virtual personal store provider's virtual personal store sales manager 53, through external interface 80 interacts with a shipment service to perform the actual shipment to the user's physical address.

Physical product purchasing process can happen off-line like content purchasing. If the connection 63 to the distributor's sale routing, or 67 from it to the virtual personal store provider, the user can choose to use an off-network channel e.g. SMS, voice phone call to perform ordering through an external interface 81.

The virtual personal store sales manager supports a large variety of payment mechanisms. Example is an electronic pre-paid card, stored in the user's personal storage, where the user's local virtual personal store sales manager 33 deducts the amount from the card and sends a proof to the provider's virtual personal store sales manager 53. Another option is credit card payment, in which case, the provider's virtual personal store sales manager 53 transacts with an external clearing house through interface 80. Other models include subscription, where each user has an account held by the distributor, which is used for purchasing.

The virtual personal store provider 23 can optionally perform an auction on certain physical or virtual products. The auction is announced by the virtual personal store provider's sales manager 53, the announcement arrives to all users who have the relevant product in their virtual personal store, through the local virtual personal store sales manager 33, who notifies the user through the input and display manager 36. The user can then use its input and display manager 36 to submit a bid, which is transferred to the local virtual personal store manager 33, through the distributor's sales routing 43 to the virtual personal store provider's sales manager 53, who elects the price, and the users who can purchase the product. The provider's virtual personal store sales manager 53 then notifies the user's virtual personal store sales manager 33 who performs the purchase in any one of the ways mentioned above.

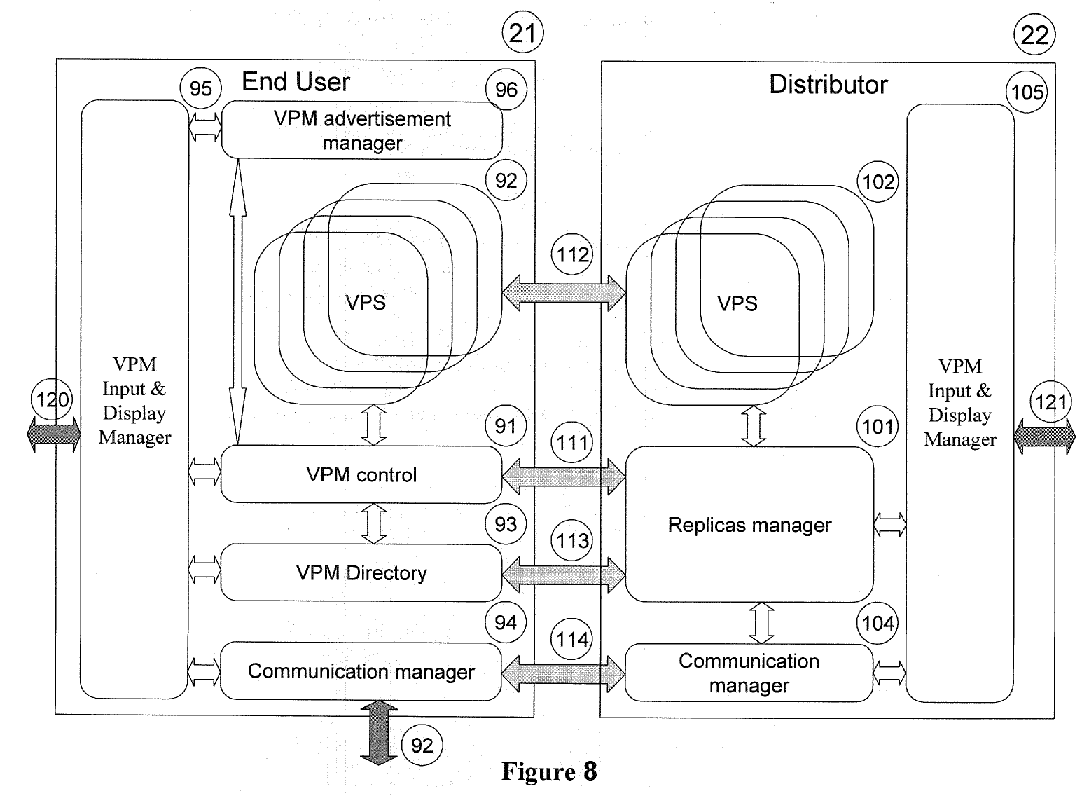

The virtual personal store described above, can be used to construct a virtual personal mall. FIG. 8 contains a high level block diagram of a virtual personal mall. A virtual personal mall can shared by a group of users, creating a community that can get organized and perform for example group purchasing. A virtual personal mall includes mechanisms that enable virtual personal store providers to conduct promotions dedicated to certain virtual personal mall. The virtual personal mall can for example conduct daily sale during which all the Virtual personal stores in the mall lower their prices by a certain percentage. The virtual personal mall communication manager 94 and 104 enables virtual personal mall community communication through external communication systems such as IM, SMS, VOIP etc. For this purpose it interfaces both external communication systems through interface 92, and the replicas manager 101 the central virtual personal mall control module.

A virtual personal mall contains promotion spaces which do not belong to any virtual personal store but to the virtual personal mall. These spaces are controlled by a virtual personal mall advertisement manager 96.

A virtual personal mall is a system organized in the user's local storage comprising components as depicted, for example, in FIG. 8.

At the user's end 21, one or more virtual personal stores 92. Some of the virtual personal store modules FIG. 3 must appear per-virtual personal store, for example virtual personal store control; other modules can be separate per virtual personal store, or shared between Virtual personal stores in the same virtual personal mall, the decision is implementation specific. Some of the modules will benefit considerably if they will be shared by all the Virtual personal stores in the virtual personal mall, e.g. the user profile module 35. Virtual personal mall input and display manager 95 is responsible the get the user's input during virtual personal mall construction and maintenance, and display virtual personal mall information which includes the Virtual personal stores and the spaces between them, to the user. Virtual personal mall control 91: responsible to provision, organize and present the Virtual personal stores included in the virtual personal mall, and enable selection by the user. The virtual personal mall control 91 interacts with the user through the virtual personal mall input and display manager 95. It interacts with each one of the virtual personal store controls 92 in the virtual personal mall.

The virtual personal mall control 91 enables the user to publish its virtual personal mall. This is done through interface 113 with the distributor's replica manager. The virtual personal mall control uses virtual personal mall structural information stored in the virtual personal mall directory 93, and sends it to the replica manager, who can distribute it to authorized users who want to share this virtual personal mall. The virtual personal mall control attaches to the virtual personal mall structure sent to the replica manager 101 access policy which indicates which users are authorized to share this virtual personal mall.

The user has at least two optional ways to construct a virtual personal mall. First, the user can view the Virtual personal stores he has, and organize them into a virtual personal mall. The virtual personal mall control 91 delivers the virtual personal store list to the virtual personal mall input and display manager 95, the user selects Virtual personal stores from the list, and organized them into a virtual personal mall. Each virtual personal store can be accompanied by a video describing the shops, and the virtual personal mall itself can be visualized using virtual reality techniques. Second, the user can retrieve a virtual personal mall published by other users from the distributor's replica manager 101. The virtual personal mall control requests the list of public Virtual personal malls from the replica manager 101; the replica manager checks if the user is authorized to share this manager. If the answer is yes, then the virtual personal mall control 91 receives the virtual personal mall structure from the replica manager 101, and constructs the virtual personal mall. Per the user's choice existing Virtual personal stores can be merged into the virtual personal mall; other Virtual personal stores might be deleted, or display outside the virtual personal mall.

Virtual personal mall directory 93 enables the user to search the Virtual personal stores in its virtual personal mall. It contains a data base and a search engine. The directory holds the virtual personal mall structure information, which is sent to the replica manager 101 when the virtual personal mall is published.

Communication manager 94 enables the users of a virtual personal mall to communicate with each other in order for example to organize group auctions. The communication is initiated by the user through the virtual personal mall input and display manager 95, since the local communication manager does not have information on the virtual personal mall community user it interacts with the distributor's virtual personal mall communication manager 104, which handles virtual personal mall community external distribution lists. The local virtual personal mall communication manager 94 asks the user for external contact information e.g. IM identity, cellular phone # etc. which he posts to the distributor's communication manger 104, together with communication policy, which defines who and under which conditions can he be contacted.

Advertisement manager 96 is responsible to virtual personal mall advertisement which happens outside of the virtual personal stores e.g., in virtual personal mall spaces. The distributor 22 and the virtual personal store provider 23 view the advertisement manager as yet another advertisement virtual shelf, hence the advertisement manager appears only at the user's machine.

At the distributor's side, one or more Virtual personal stores 102; these are the distributor's control 51, sales 53, tracking 52, manager 54, store 57 and input and display manager 56. Commonly the Virtual personal stores blocks are kept separated; but if a specific implementation requires blocks sharing between virtual personal stores e.g. tracking, it can be done.

Replicas manager 101 is responsible to virtual personal mall sharing by a community of users. It receives virtual personal mall structural information from the virtual personal mall builder virtual personal mall control 91, together with access policy. It stores this information in its local store. The replica manager also maintains the list of users sharing Virtual personal malls. This list is used only for inter-user communication through the communication manager 94 and 104, and not for products distribution which is done by the virtual personal store manager, while optionally preserving privacy.

Communication manager 104 is responsible for the constructing and maintaining virtual personal mall community lists. The communication manager receives an indication from the replica manager 101 when a new virtual personal mall is published. It then creates a new community for this virtual personal mall which initially contains only the virtual personal mall builder. When it receives an indication from the replica manage 101 that a new user is sharing a specific virtual personal mall, it adds the user's information to the virtual personal mall's community. The community holds for each user its identity and its external identifiers e.g. IM identity, cellular phone number etc.

Upon a request from a user's communication manager 94, the distributor's communication manager 104 sends it the community distribution list, after removing from the list all the users who's communication policy indicates that the user cannot contact them under the current conditions.

Virtual personal mall input and display manager 105 enables the distributor to display information on existing Virtual personal malls and communities. It can also display aggregated virtual personal mall tracking information, received from various virtual personal mall control modules through virtual personal store tracking.

The virtual personal store provider 23 can optionally be aware to the existence of the virtual personal mall. All the virtual personal mall features described above can be implemented without the awareness of the virtual personal store provider. Optionally, several virtual personal store providers might conduct joint promotions or sales to virtual personal mall communities. This will require virtual personal mall control module on the virtual personal store provider side as well, the description of which is skipped in this application.

The following is an example of virtual personal mall search process. The user enters a series of search criteria through his virtual personal mall input and display manager 95 and defines new virtual personal mall views. The virtual personal mall input and display manager 95 displays the virtual personal mall, organized according to the new search criteria. The following is an example of virtual personal mall publishing process. The user instructs the virtual personal mall control 91 through the virtual personal mall input and display manager 95, to export his virtual personal mall to the replica manager 101. The virtual personal mall structure consists of the list Virtual personal stores in the mall, for each of them a list of virtual shelves, and optionally some organizational and structural information, it is read from the virtual personal mall directory 93, and posted to the virtual personal mall replica 101. The user also attached to the virtual personal mall structure policy indicating which users are authorized to share his virtual personal mall. The virtual personal mall control 91, posts the virtual personal mall to the replica manager 101, who writes it in his local store. It is to be understood that the invention is not limited in its application to the details set forth in the description contained herein or illustrated in the drawings. The invention is capable of other embodiments and of being practiced and carried out in various ways. It should be noted that the invention is not bound by the specific algorithm of processing or specific structure. Those versed in the art will readily appreciate that the invention is, likewise, applicable to any other processing or presentation with equivalent and/or modified functionality which may be consolidated or divided in another manner.

We claim:

1. A computer-implemented method of providing and displaying personalized product information comprising:
obtaining a user profile;
based on said user profile, receiving from a remote server product parameters pertaining to a plurality of products;
storing said product parameters on a local storage device;
displaying to a user a plurality of virtual stores; and
upon selection of one of said virtual stores, displaying product information pertaining to at least a portion of said products associated with said virtual store, wherein the products are displayed in groups of virtual shelves based on respective product parameters associated with said products.

2. The method of claim 1, wherein said product parameters include an expiration time, and wherein displaying said product information comprises displaying said product information only prior to said expiration time.

3. The method of claim 1, further comprising communicating an order of at least one of said products to a merchant of said product.

4. The method of claim 3, further comprising reporting said order to said remote server.

5. The method of claim 3, further comprising updating said user profile based on said order.

6. The method of claim 1, wherein at least a portion of said products are digital content products, and the method further comprising communicating an order of at least one of said digital content products to a merchant of said digital content product, receiving said digital content product from said merchant of the ordered digital content product, and storing said digital content product on said local storage device.

7. The method of claim 1,
wherein said user profile includes identification of at least one community group,
wherein receiving said product parameters pertaining to a plurality of products is based on said community group, and
wherein at least a portion of said products are grouped into a virtual shelf based on said community group associated with said products.
